(19) United States
(12) Patent Application Publication
(10) Pub. No.: US 2011/0146906 A1
(43) Pub. Date: Jun. 23, 2011

(54) Double Vacuum Cure Processing of Composite Parts

(75) Inventors: Michael R. Anderson, Renton, WA (US); Edoardo P. Depase, Seattle, WA (US)

(73) Assignee: The Boeing Company

(21) Appl. No.: 12/641,897

(22) Filed: Dec. 18, 2009

(51) Int. Cl. B32B 37/10; B29C 35/02; B29C 35/16; B32B 37/06

(52) U.S. Cl. 156/285; 425/445; 156/382; 264/101

(57) ABSTRACT

Out-of-autoclave curing of a composite part is performed using a double vacuum chamber assembly comprising integrated inner and outer vacuum chambers.

### TECHNICAL FIELD

This disclosure generally relates to equipment and methods for making composite parts, and deals more particularly with double vacuum cure processing of composites.

### BACKGROUND

Autoclaves are widely used to cure composite parts having higher performance specifications requiring tight dimensional tolerances and low porosity. Heating the composite within an autoclave results in a chemical reaction that both cures the resin and produces volatiles inside the composite that are driven out by pressure applied to the atmosphere within the autoclave. Similarly, pressclaves may be used to cure composites by applying heat and pressure to a heated part through an inflatable bladder. Autoclaves, pressclaves and similar equipment may be undesirable for use in some applications, however, due to their higher capital cost and the labor they require for setup and operation. Furthermore, autoclave and pressclave cure processing may be limited by the size of parts that can be processed.

Double vacuum bag (DVB) processing may also be employed to cure composite parts such as prepreg laminates. Unlike autoclave curing, DVB processing is not limited by the size of the part. The DVB process is also less capital equipment intensive than autoclave processing, and may provide tighter dimensional control and higher mechanical performance in the cured part compared to autoclave processing or single vacuum bag (SVB) processing.

Prior DVB equipment and processing methods can be relatively labor intensive and time consuming. DVB equipment comprises inner and outer vacuum bags that must be individually positioned and sealed to a tool base using hand labor. The bags must each be leak checked before processing begins. Additionally, the current DVB processing technique requires an intermediate low temperature hold step during the processing cycle in which the temperature of the part is held at a substantially constant level for a period of time as the part is ramped up to a desired cure temperature. This intermediate low temperature hold adds to the overall processing time of the part.

Accordingly, there is a need for a simplified double vacuum cure apparatus and related method for curing composite parts that both reduces labor costs and processing times.

### SUMMARY

The disclosed embodiments provide apparatus and a related method for curing a prepreg laminate using double vacuum processing. The apparatus is effective in removing volatiles, and may produce parts exhibiting reduced dimensional tolerance variations and improved mechanical properties. Time and labor needed to set up equipment and cure parts may be reduced through the use of an integrated double vacuum chamber assembly comprising a flexible inner bag that is permanently attached to a substantially rigid outer shroud. Use of the apparatus may allow reduction or elimination of an intermediate low temperature hold as the temperature of the part is being increased to the cure temperature, thereby further reducing processing time. The method and apparatus may be used to produce composite parts during an original manufacturing process or to rework parts using composite patches.

According to one disclosed embodiment, apparatus is provided for curing a composite part. The apparatus comprises a cure tool against which the part may be compressed during curing. A generally rigid shroud forms a first outer vacuum chamber over the composite part, and a vacuum bag covered by the shroud forms a second inner vacuum chamber over the composite part. Means may be provided for securing the bag to the shroud, which may include an adhesive. In one variation, the bag may include magnetic means for attaching the periphery of the bag to the tool.

According to another embodiment, apparatus is provided for out-of-autoclave curing of an uncured composite part, comprising a tool on which the uncured part may be placed, and a double vacuum chamber assembly. The double vacuum chamber assembly includes a generally rigid portion forming the first outer vacuum chamber and a generally flexible portion forming an inner vacuum chamber. The flexible portion of the vacuum chamber assembly is substantially disposed within and attached to the first portion. Each of the flexible and rigid portions of the vacuum chamber assembly may include a vacuum port for allowing a vacuum to be drawn in the chamber. The tool may include at least one opening therein through which warm air may be received for directly heating the tool. The apparatus may further comprise a thermal mass attached to the tool for improving heat transfer through the tool to the part.

According to a disclosed method embodiment, curing a composite part comprises placing the part on a tool and drawing first and second vacuums over the part. The temperature of the part is increased substantially continuously and at a substantially constant rate to a preselected cure temperature. The first vacuum is reduced as the temperature of the part is being increased to the cure temperature. The method further comprises maintaining the temperature of the part substantially at the cure temperature for a preselected period, and reducing the temperature of the part after the cure temperature has been maintained for the preselected period. The vacuum in the inner chamber is held substantially constant as the temperature is increased continuously to the cure temperature as well as during the period that the temperature is being maintained at the cure temperature. Drawing the first and second vacuums may be performed by placing a flexible bag over the part, forming a substantially vacuum type seal between the bag and the tool, drawing air from the bag through a vacuum port in the tool, placing a substantially rigid shroud over the bag and the part, and drawing air from the shroud through a vacuum port in the shroud.

According to a further embodiment, a method is provided of curing a composite part comprising placing the part against a tool and drawing first and second vacuums over the part. The method further comprises increasing the temperature of the part substantially continuously to a preselected cure temperature, including changing the rate of temperature increase at least once as the temperature is continuously increased. The method also includes reducing the amount of the first vacuum as the temperature of the part is being continuously increased to the cure temperature. The temperature of the part is maintained substantially at the cure temperature for a preselected period. The temperature of the part is reduced after the cure temperature has been maintained for the preselected period.

According to another embodiment, a method is provided of curing and removing volatiles from a composite patch used to rework an area of a structure. The method comprises forming a double vacuum chamber assembly and placing the double vacuum chamber assembly over the patch. The double vacuum chamber assembly is sealed to the structure around the patch, and is used to draw first and second vacuums over the patch. The method further comprises increasing the temperature of the patch substantially continuously to a preselected cure temperature, and reducing the amount of the first vacuum as the temperature of the patch is being increased to the cure temperature. The temperature of the patch is maintained substantially at the cure temperature for a preselected period and is then reduced after the cure temperature has been maintained for the preselected period.

The disclosed embodiments provide apparatus and a related method for double vacuum curing of composite laminates which obviate the need for autoclave processing, and may produce parts exhibiting reduced part-to-part dimensional variations and improved mechanical properties.

### BRIEF DESCRIPTION OF THE ILLUSTRATIONS

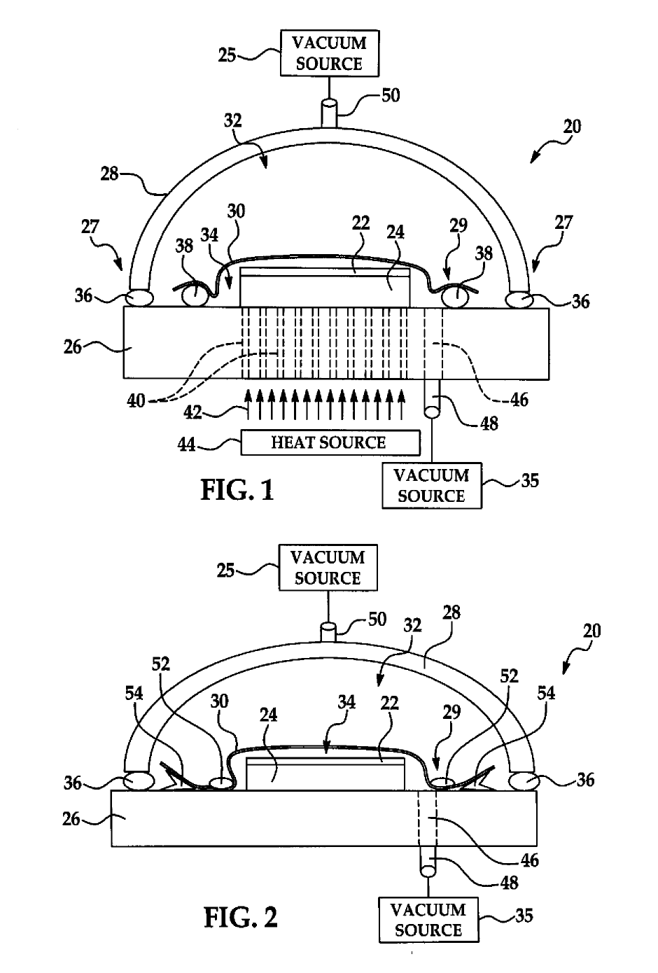

FIG. 1 is an illustration of a sectional view of apparatus for double vacuum curing of composite laminates according to one embodiment.

FIG. 2 is an illustration of a sectional view of an alternate form of the apparatus in which magnetic means are employed to attach the flexible inner bag to a tool.

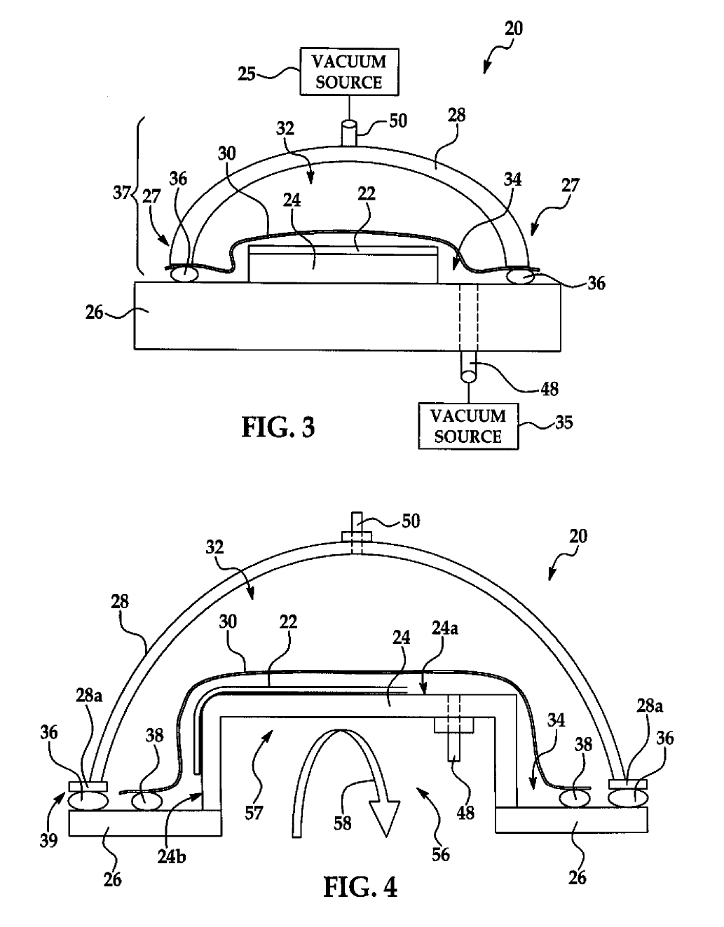

FIG. 3 is an illustration of a sectional view of another embodiment of the apparatus in which the flexible inner bag and outer rigid shroud are integrated into a single assembly.

FIG. 4 is an illustration of a sectional view of another embodiment of the apparatus in which an opening is provided in the tool for improving heating of the tool.

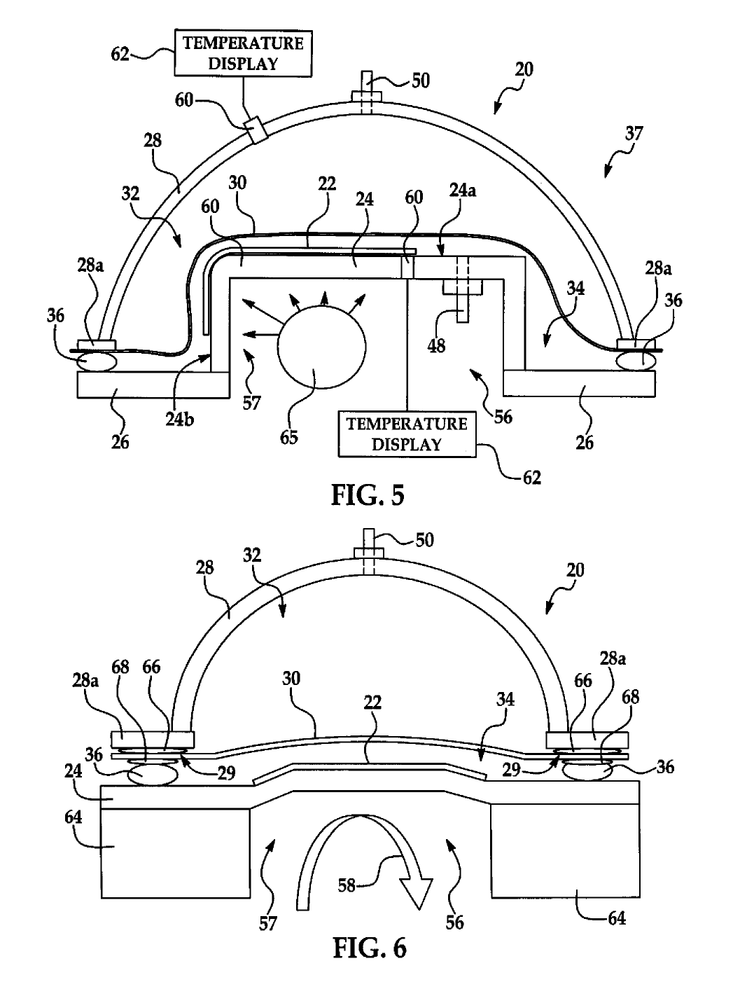

FIG. 5 is an illustration of a further embodiment of the apparatus employing thermocouples and the use of a heating source integrated into the tool.

FIG. 6 is an illustration of another embodiment of the apparatus in which a thermal mass has been added to the tool to improve heat transfer to the part.

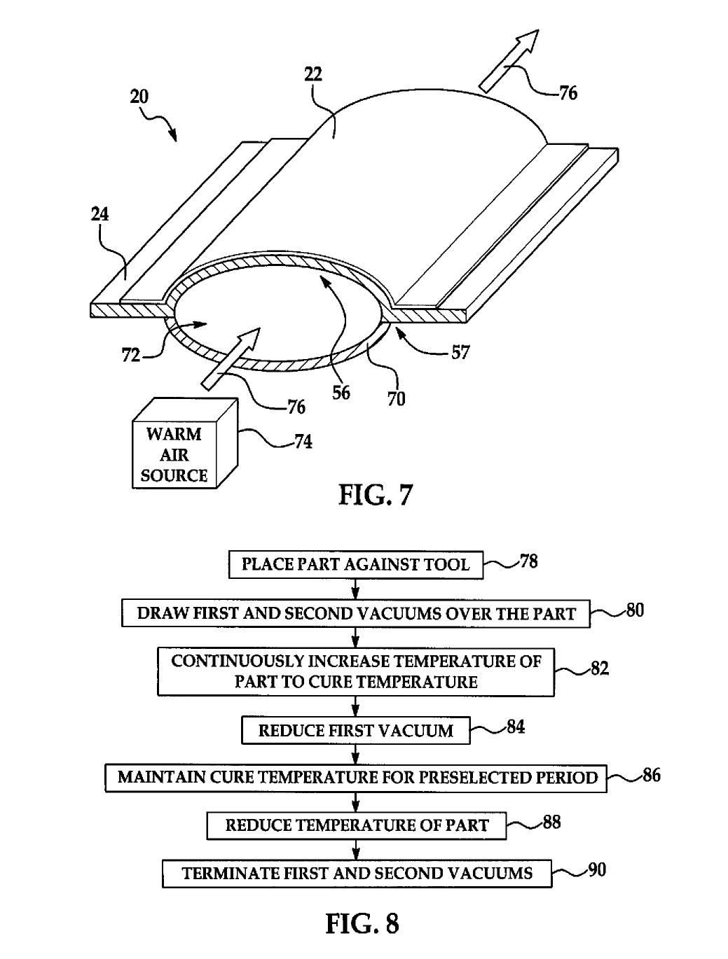

FIG. 7 is an illustration of a perspective view of another embodiment of the apparatus in which a heating conduit is integrated into the tool.

FIG. 8 is an illustration of a flow diagram showing the steps of a method of double vacuum curing a composite laminate.

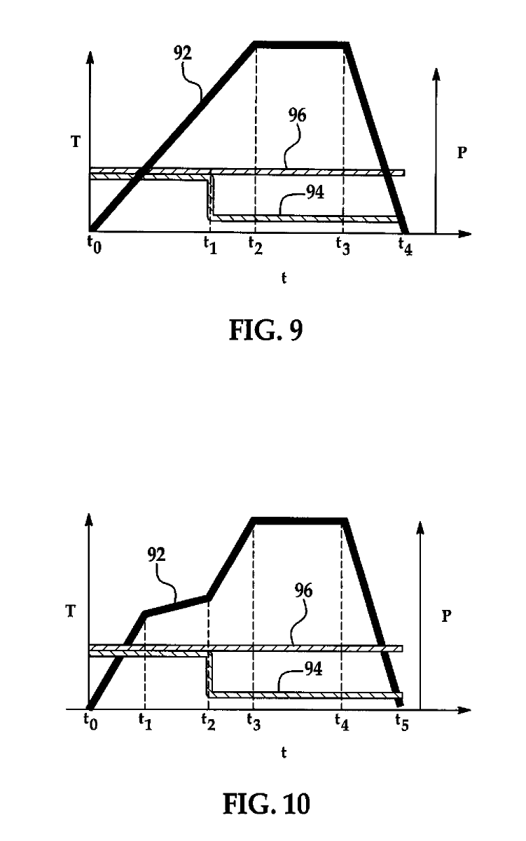

FIG. 9 is an illustration of a graph showing the relationship between temperature and vacuum pressure over time according to one process embodiment.

FIG. 10 is an illustration of a graph similar to FIG. 9, for an alternate process embodiment.

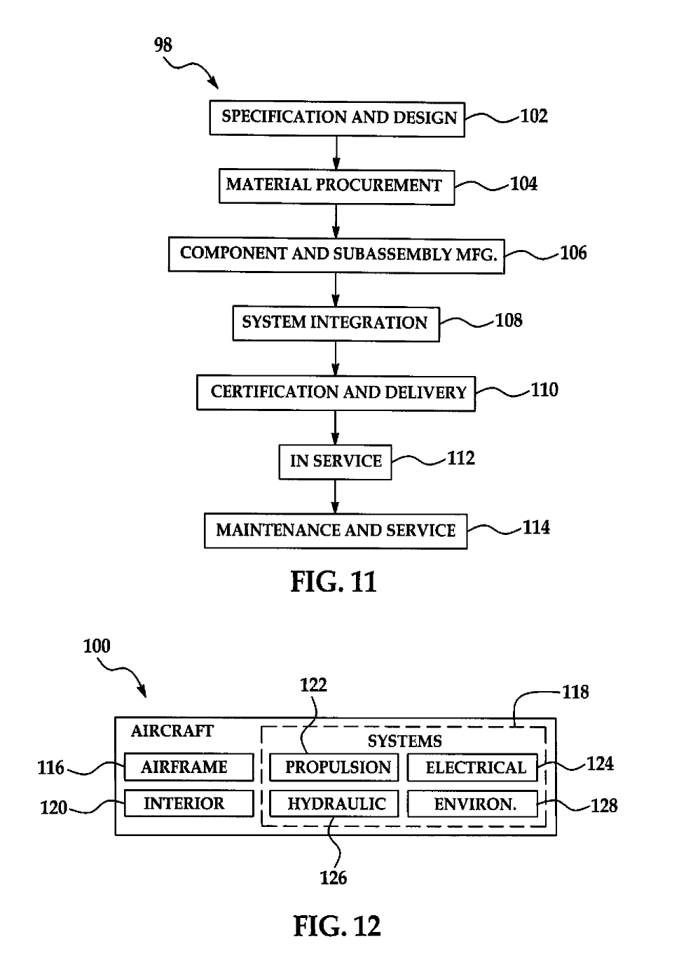

FIG. 11 is an illustration of a flow diagram of aircraft production and service methodology.

FIG. 12 is an illustration of a block diagram of an aircraft.

### DETAILED DESCRIPTION

Referring first to FIG. 1, a double vacuum chamber apparatus 20 is used to perform out-of-autoclave curing of a composite part 22. As used herein, “part” and “composite part” are used in their broadest sense and include but are not limited to various forms of structures, such as, without limitation, beams, supports, panels, structural and non-structural members, elements and subassemblies, to name only a few. The part 22 may comprise a multi-ply prepreg laminate which is placed on or against a tool 24 supported on a metallic tool base 26. A substantially rigid outer shroud 28 is sealed around its outer periphery 27 to the tool base 26 by a seal 36, thereby forming a first, outer vacuum chamber 32 over the composite part 22. In one embodiment, the seal 36 may comprise a reusable elastomeric seal that is permanently affixed to the periphery 27 of the outer shroud 28. The outer shroud 28 may comprise any suitable material such as a metal or a composite that possesses sufficient rigidity to allow the shroud 28 to be substantially self-supporting and retain its shape. The shroud 28 may possess any of various shapes both in footprint and cross section, that is suitable for covering the particular part 22 to be cured. The outer shroud 28 includes a vacuum port 50 connected with a suitable vacuum source 25 which is operable to draw a desired vacuum in the outer vacuum chamber 32.

A flexible, inner vacuum bag 30 contained inside the outer shroud 28 also covers the part 22 and is sealed around its periphery 29 to the tool base 26, thereby forming a second, inner vacuum chamber 34 over the part 22. The bag 30 may comprise, for example and without limitation, a conventional one-time-use nylon bag and the seal 38 may be a conventional, non-reusable sealant. Alternatively, the bag 30 may be a reusable type made of, for example and without limitation, an elastomeric material, and the seal 38 may comprise a reusable elastomeric seal. Although not shown in FIG. 1 for purposes of clarity, additional layers of material may be placed on the part 22, beneath the flexible bag 30, including but not limited to separator films, breathers and caul plates.

The tool base 26 may include a passageway 46 therein which communicates with the inner vacuum chamber 34. The passageway 46 is coupled through a vacuum port 38 to a vacuum source 35 which is used to draw a desired level of vacuum within the inner vacuum chamber 34 during cure processing. The tool base 26 may also include one or more vent openings 40 therein to allow heat indicated by the arrows 42 from a heat source 44 to be vented directly against the tool 24. Alternatively, cure processing using the apparatus 20 may be performed within an oven (not shown) which is used to heat the composite part 22 to the required cure temperature.

FIG. 2 illustrates an alternate embodiment of the apparatus 20 in which a reusable type elastomeric inner vacuum bag 30 covers the composite part 20. The bag 30 includes a magnetic strip 52 integrated into and surrounding the periphery of the bag 30 for holding the bag 30 against the metallic tool base 26. The bag 30 further includes a reusable vacuum seal 54 permanently bonded to the bag 30 for creating a vacuum tight seal outside of the magnetic strip 52 and surrounding the part 22. Integration of the bag 30, the magnetic strip 52 and the reusable seal 54 into a single assembly allow the bag 30 to be quickly deployed over the part 22 and sealed to the tool base 26.

Attention is now directed to FIG. 3 which illustrates another embodiment of the apparatus 20 in which the inner, flexible bag 30 is permanently attached to the periphery 27 of the outer shroud 28 so that the outer shroud 28 and inner bag 30 form a single double vacuum chamber assembly 37 that may be easily and quickly placed on and sealed to the tool base 26, covering the part 22. The integration of the outer shroud 28, inner bag 30 and seal 36 into a single assembly 37 permits checking the outer shroud 28 and inner bag 30 for leaks before they are installed over the part 22, thus reducing processing time. In this example, a reusable seal 36 is attached to the periphery 27 of the shroud 28, with the inner bag 30 sandwiched therebetween so that the seal 36 functions to seal both the outer and inner vacuum chambers 32, 34 respectively on the tool base 26.

It should be noted here that while the various embodiments are described in connection with producing original composite parts as part of a manufacturing process, various components of the apparatus including the double vacuum chamber assembly 37, and well as the disclosed method may be employed to rework parts or structures. For example the embodiments may be employed to cure a composite patch (not shown) and remove volatiles therefrom that is used to rework a portion of a structure such as an aircraft skin (not shown), either to improve the structure or to restore the structure to original specifications. In a rework application of the embodiments, the double vacuum chamber assembly 37 may be placed on and sealed to the structure, rather than to a tool base 26 as shown in the Figures.

Attention is now directed to FIG. 4 which illustrates another embodiment of the apparatus 20 in which a tool 24 mounted on a tool base 26 includes a generally U-shaped cross section forming an opening 56 on the backside 57 of the tool 24. The opening 56 allows warm air shown by the arrow 58 from a suitable heat source (not shown) to circulate evenly around and directly contact the backside 57 of the tool 24, thereby improving the transfer of heat to the composite part 22. In this particular example, the tool 24 includes a pair of tool surfaces 24a, 24b for heating and maintaining the shape of the part 22. The outer shroud 28 is provided with a peripheral flange 28a which forms a surface 39 against which the seal 36 may conform to create a vacuum tight seal around the outer vacuum chamber 32.

Referring now to FIG. 5, a further form of the apparatus 20 includes a substantially rigid outer shroud 28 to which the inner flexible bag 30 and the reusable seal 36 are permanently attached so that the shroud 28, bag 30 and seal 36 may be installed and removed over the part 22 as a single assembly 37. In this example, thermocouples 60 may be provided in the shroud 28 and/or in the tool 24 in order to measure the temperature of the part 22. Suitable displays 62 may be provided to display the temperature sensed by the thermocouples 60. In this embodiment, a radiant or other form of heat source 65 may be placed within the opening 56 so as to be in close proximity to and direct heat along the back side 57 of the tool 24 in order to increase the efficiency and reduce the time required for heat transfer to the part 22.

FIG. 6 illustrates still another embodiment of the apparatus 20 in which a thermal mass 64 comprising a thermally conductive material such as, without limitation, copper or aluminum, is attached to the backside 57 of the tool 24 in order to further maximize the speed and efficiency of heat transfer to the part 22, as well as to heat the part 22 more uniformly. The embodiment of the apparatus 20 shown in FIG. 6 utilizes an integrated double vacuum chamber configuration, similar to that shown in FIGS. 3 and 5. The outer periphery 29 of the bag 30 is bonded to the flange 28 on the shroud 28 by a layer of adhesive 66. The seal 36 is in turn bonded to the periphery 30 of the bag 30 by a second layer of adhesive 68.

FIG. 7 illustrates an embodiment of the apparatus 20 in which an opening 56 in the backside 57 of the tool 24 is closed by a cover 70 to form a conduit 72 through the tool 24. A suitable source of warm air 74 may direct warm air through the conduit 72 as shown by the arrows 76 in order to directly warm the backside 57 of the tool 24 and thus the part 22. The outer shroud 28 and the inner bag 30 are not shown in FIG. 7 for purposes of clarity.

FIG. 8 illustrates the steps of a method for double vacuum curing of a composite part 22 which may employ the apparatus 20 shown in FIGS. 1-7. Beginning at step 78, an uncured composite part 22 is placed on or against a suitable cure tool 24. As shown at 80, first and second vacuums are then drawn over the part 22 using the vacuum chambers 32, 34 respectively formed by the outer shroud 28 and the inner bag 30. As will be discussed below in more detail, initially the level of the first vacuum may be nearly equal to that of the second vacuum. At step 82, with the first and second vacuums having been drawn, the temperature of the part 22 is continuously increased through heating until the part temperature reaches a preselected cure temperature. As will be explained below, the part temperature may or may not be increased at a constant rate, however, it is increased substantially continuously. As the temperature of the part 22 is being increased to the cure temperature, the first vacuum is reduced to some preselected level, as shown at step 84 so that the level of the second vacuum is greater than the level of the first vacuum. Once the part 22 reaches the cure temperature, the cure temperature is maintained, as shown at step 86 for a preselected period during which the part 22 cures. After the part 22 is cured, the temperature of the part 22 is reduced as shown at step 88, and the first and second vacuums are terminated as shown at step 90.

FIGS. 9 and 10 respectively illustrate vacuum pressure and temperature profiles according to two differing processing schedules suitable for double vacuum curing of the composite part 22. As previously noted however, the disclosed method utilizing the processing schedules shown in FIGS. 9 and 10 may also be used to remove volatiles and cure composite patches (not shown) used to rework an area of a part or structure. Referring particularly to FIG. 9, the temperature of the part 22 indicated by plot 92 is continuously increased at a substantially constant rate from time t₀ to t₂ until the preselected cure temperature has been reached at t₂. Beginning at t₀, the vacuum pressures in the outer and inner vacuum chambers 32, 34, respectively represented by plots and 96 are drawn to preselected levels, which may be nearly equal. In some cases, the first vacuum pressure 94 in the outer vacuum chamber 32 may be slightly below, at or slightly above the vacuum pressure 96 in the inner chamber 34.

In this embodiment, the vacuum pressure 96 in the inner chamber 34 is maintained substantially constant during the entire process cycle. However, at some point, t₁ between t₀ and t₂, the vacuum pressure 94 in the outer vacuum chamber 32 is reduced to a level that is materially less than the vacuum pressure 96 in the inner vacuum chamber 34. During the period between t₀ and t₁, because the two pressures 94, 96 are nearly equal, the vacuum pressure 94 in the outer vacuum chamber 32 prevents the inner bag 30 from applying full compaction pressure on the part 22, thereby allowing volatiles in the part 22 to escape more readily as the temperature 92 is being ramped up to the cure temperature. At time t₁, however, the reduction of the vacuum pressure 94 allows the vacuum pressure 96 in the inner chamber 34 to apply nearly full pressure to the part 22 in order to compact the part 22 and force out air pockets in the laminate part 22 to avoid porosities. The period between t₂ and t₃ represents the preselected period during which the temperature 92 is maintained at a constant cure temperature. Beginning at t₃, the temperature 92 is ramped down during a cooling cycle to an ambient temperature at t₄, at which point the vacuum pressures 94, 96 may be terminated.

FIG. 10 illustrates a cure processing schedule which is generally similar to FIG. 9 however ramping of the temperature 92 to the cure temperature, though continuous, is not constant, but rather includes one or more changes in the rate of temperature increase. In the illustrated example, the temperature 92 is increased between t₀ and t₁ at a rate that is greater than that shown in the schedule of FIG. 9. However, at t₁, the rate of temperature increase is reduced until t₂ at which point the temperature ramp rate is resumed until the cure temperature is reached at t₃.

Embodiments of the disclosure may find use in a variety of potential applications, particularly in the transportation industry, including for example, aerospace, marine and automotive applications. Thus, referring now to FIGS. 11 and 12, embodiments of the disclosure may be used in the context of an aircraft manufacturing and service method 98 as shown in FIG. 11 and an aircraft 100 as shown in FIG. 12. During pre-production, exemplary method 98 may include specification and design 102 of the aircraft 100 and material procurement 104. During production, component and subassembly manufacturing 106 and system integration 108 of the aircraft 100 takes place. The disclosed methods and apparatus may be used to cure composite parts manufactured during step 106 and integrated in step 108. Thereafter, the aircraft 100 may go through certification and delivery 110 in order to be placed in service 112. While in service by a customer, the aircraft 100 is scheduled for routine maintenance and service 114 (which may also include modification, reconfiguration, refurbishment, and so on). The disclosed methods and apparatus may be used to cure composite parts that are installed on the aircraft 100 during the maintenance and service 114.

Each of the processes of method 98 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 12, the aircraft 100 produced by exemplary method 98 may include an airframe 116 with a plurality of systems 118 and an interior 120. Examples of high-level systems 118 include one or more of a propulsion system 122, an electrical system 124, a hydraulic system 126, and an environmental system 128. Any number of other systems may be included. Although an aerospace example is shown, the principles of the disclosure may be applied to other industries, such as the marine, automotive and construction industries.

The apparatus and methods embodied herein may be employed during any one or more of the stages of the production and service method 98. For example, components or subassemblies corresponding to production process 98 may be fabricated or manufactured in a manner similar to components or subassemblies produced while the aircraft 100 is in service. Also, one or more apparatus embodiments, method embodiments, or a combination thereof may be utilized during the production stages 106 and 108, for example, by substantially expediting assembly of or reducing the cost of an aircraft 100. Similarly, one or more of apparatus embodiments, method embodiments, or a combination thereof may be utilized while the aircraft 100 is in service, for example and without limitation, to maintenance and service 114.

Although the embodiments of this disclosure have been described with respect to certain exemplary embodiments, it is to be understood that the specific embodiments are for purposes of illustration and not limitation, as other variations will occur to those of skill in the art.

What is claimed:

1. Apparatus for curing a composite part, comprising:
a cure tool against which the part may be compressed during curing;
a generally rigid shroud forming a first outer vacuum chamber over the composite part; and
a vacuum bag covered by the shroud and forming a second inner vacuum chamber over the composite part

2. The apparatus of claim 1, further comprising:
means for securing the bag to the shroud.

3. The apparatus of claim 2, wherein the means for securing the bag to the shroud includes a layer of adhesive.

4. The apparatus of claim 2, wherein the means for securing the bag to the shroud includes a substantially vacuum tight seal between the shroud and the bag.

5. The apparatus of claim 2, wherein the shroud and the tool each include a vacuum port for allowing a vacuum to be drawn in the inner and outer vacuum chambers.

6. The apparatus of claim 2, wherein the tool includes at least one opening therein adapted to receive heat for heating the tool and the part.

7. The apparatus of claim 1, wherein the bag includes magnetic means for attaching the periphery of the bag to the tool.

8. Apparatus for out-of-autoclave curing an uncured composite part, comprising:
a tool on which the uncured part may be placed; and,
a double vacuum chamber assembly forming inner and outer vacuum chambers over the uncured part, the assembly including a generally rigid portion forming the outer vacuum chamber and a generally flexible portion forming the inner vacuum chamber, the flexible portion being substantially disposed within and attached to the first portion.

9. The apparatus of claim 8, wherein the flexible portion is attached to the rigid portion by an adhesive forming a substantially vacuum tight seal between the flexible and rigid portions around their respective peripheries.

10. The apparatus of claim 8, wherein:
the tool includes a front side on which the part may be placed, and a back side, and
the backside of the tool includes at least one opening through which warm air may be received for heating the tool.

11. The apparatus of claim 8, further comprising a thermal mass attached to a back side of the tool for improving heat transfer through the tool to the part.

12. A method of curing a composite part, comprising:
placing the part against a tool;
drawing first and second vacuums over the part;
increasing the temperature of the part substantially continuously and at a substantially constant rate to a preselected cure temperature;
reducing the amount of the first vacuum as the temperature of the part is being increased to the cure temperature;
maintaining the temperature of the part substantially at the cure temperature for a preselected period; and
reducing the temperature of the part after the cure temperature has been maintained for the preselected period.

13. The method of claim 12, wherein drawing first and second vacuums includes:
placing a flexible bag over the part,
forming a substantially vacuum tight seal between the bag and the tool,
drawing air from the bag through a vacuum port in the tool,
placing a substantially rigid shroud over the bag and the part, and
drawing air from the shroud through a vacuum port in the shroud.

14. The method of claim 13, wherein forming the first vacuum over the part includes forming vacuum tight seal between the bag and the shroud.

15. The method of claim 13, wherein placing a bag over the part using magnets to hold the periphery of the bag against the tool.

16. A method of curing a composite part, comprising:
placing the part against a tool;
drawing first and second vacuums over the part;
increasing the temperature of the part substantially continuously to a preselected cure temperature, including changing the rate of temperature increase at least once as the temperature is continuously increased;
reducing the amount of the first vacuum as the temperature of the part is being continuously increased to the cure temperature;
maintaining the temperature of the part substantially at the cure temperature for a preselected period; and
reducing the temperature of the part after the cure temperature has been maintained for the preselected period.

17. The method of claim 16, wherein reducing the amount of the first vacuum includes reducing the first vacuum to a level that results in the second vacuum applying compaction pressure to the part.

18. The method of claim 16, wherein increasing the temperature and changing the rate includes:
increasing the temperature at a first rate during a first time interval,
increasing the temperature at a second rate less than the first rate during a second time interval,
increasing the temperature at a third rate greater than the second rate during a third time interval.

19. A method of removing volatiles from a composite patch used to rework an area of a structure, comprising:
sealing a double vacuum chamber assembly to the structure around the patch;
using the double vacuum chamber assembly to draw first and second vacuums over the patch;
increasing the temperature of the patch substantially continuously to a preselected cure temperature;
reducing the amount of the first vacuum as the temperature of the patch is being increased to the cure temperature; and
removing volatiles from the patch.

20. The method of claim 19, wherein the temperature of the patch is increased substantially continuously at a substantially constant rate.

21. The method of claim 19, wherein increasing the temperature of the patch includes changing the rate of temperature increase at least once as the temperature is continuously increased.

22. The method of claim 19, further comprising:
maintaining the temperature of the patch substantially at the cure temperature for a preselected period; and
reducing the temperature of the patch after the cure temperature has been maintained for the preselected period.

23. The method of claim 19, wherein;
reducing the amount of the first vacuum includes reducing the first vacuum to a level that results in the second vacuum applying compaction pressure to the patch, and
forming the double vacuum chamber includes sealing the periphery of a flexible vacuum bag to the periphery of a substantially rigid shroud.

24. Apparatus for out-of-autoclave curing an uncured composite part, comprising:
a tool against which the uncured part may be placed, the tool having a vacuum port and further including at least one opening therein;
a source of heat for introducing heat into the opening in the tool to heat the tool and the part; and
a reusable double vacuum chamber assembly adapted to be placed over the part for compressing the part and removing volatiles from the part, the double vacuum chamber assembly including
a substantially rigid outer shroud covering the part, the shroud including a peripheral flange and forming a first outer vacuum chamber over the part,
a vacuum port in the shroud through which a vacuum may be drawn in the shroud,
a flexible bag covering the part and forming a second inner vacuum chamber over the part,
a layer of adhesive securing the bag to the peripheral flange of the shroud and forming a substantially vacuum tight seal between the shroud and the bag,
a seal for forming a substantially vacuum tight seal between the double vacuum chamber assembly and the tool, and
a layer of adhesive securing the seal to the periphery of the bag and forming a substantially vacuum tight seal between the seal and the bag.

25. A method of curing a composite part, comprising:
placing the part against a tool;
forming a first outer vacuum chamber over the part by placing a substantially rigid shroud over the part;
forming a second inner vacuum chamber over the part by placing a flexible bag over the part inside the shroud;
forming a substantially vacuum tight seal between the shroud and the bag;
forming a substantially vacuum tight seal between the bag and the tool;
drawing a vacuum in the first vacuum chamber;
drawing a vacuum in the second vacuum chamber;
heating the tool and the part at a substantially constant rate until the tool and part reach a preselected cure temperature;
reducing the vacuum in the first vacuum chamber as the tool and the part are being heated to the cure temperature;
maintaining the temperature of the tool and the part substantially at the cure temperature for a preselected period;
reducing the temperature of the tool and part after the cure temperature has been maintained for the preselected period; and,
terminating the vacuums in the first and second vacuum chambers.
